(19) United States
(12) Patent Application Publication
(10) Pub. No.: US 2026/0300297 A1
(43) Pub. Date: Oct. 1, 2026

(54) INFORMATION PROCESSING APPARATUS AND INFORMATION PROCESSING METHOD

(71) Applicant: NEC Corporation, Toko (JP)

(72) Inventors: Yoshiaki SAKAE, Tokyo (JP); Masaharu MORIMOTO, Tokyo (JP); Joe BRINTON, Tokyo (JP); Sianen OOI, Tokyo (JP); Masaki INOKUCHI, Tokyo (JP); Ryosuke HOTCHI, Tokyo (JP); Shunsuke OSAKI, Tokyo (JP); Tatsuya FUKUDA, Tokyo (JP)

(73) Assignee: NEC Corporation, Tokyo (JP)

(21) Appl. No.: 19/567,682

(22) Filed: Mar. 16, 2026

(30) Foreign Application Priority Data
Mar. 26, 2025 (JP) 2025-052245

(51) Int. Cl. G06F 16/2455; G06F 16/2452; G06N 3/0475

(52) U.S. Cl. CPC G06F 16/2455; G06N 3/0475; G06F 16/24522

(57) ABSTRACT

An information processing apparatus includes at least one memory storing instructions and at least one processor configured to execute the instructions to select a reference information DB to be searched from among a plurality of reference information DBs based on an attribute recorded as meta-information of a reference information DB, the attribute being common to reference information recorded in the reference information database, and search for reference information to be referred to by a generative model with the reference information DB selected by the narrow-down unit as a target. It can also be said that the information processing apparatus contributes to optimization in the search for the reference information.

### INCORPORATION BY REFERENCE

This application is based upon and claims the benefit of priority from Japanese patent application No. 2025-052245, filed on Mar. 26, 2025, the disclosure of which is incorporated herein in its entirety by reference.

### TECHNICAL FIELD

The present disclosure relates to an information processing apparatus and an information processing method.

### BACKGROUND ART

In various fields, use of a Large Language Model (LLM) has been studied. A related art related to the LLM includes, for example, that described in Andrei-Laurentiu Bornea etc., “Telco-RAG: Navigating the Challenges of Retrieval Augmented Language Models for Telecommunications”, arXiv:2404.15939v3 [cs.IR], Aug. 7, 2024. Andrei-Laurentiu Bornea etc., “Telco-RAG: Navigating the Challenges of Retrieval Augmented Language Models for Telecommunications”, arXiv:2404.15939v3 [cs.IR], Aug. 7, 2024 discloses a technology called Telco-RAG that can be used to create a document of Third Generation Partnership Project (3GPP) (registered trademark).

The Telco-RAG is obtained by adding a search process before search by a Retrieval-Augmented Generation (RAG) in a framework of document creation by the LLM using a normal RAG. In the added search process, a related document related to the query input by the user from the document corpus is specified by using a neural network (hereinafter abbreviated as NN) that has learned a correspondence between a query and a series of 3GPP specifications. By adding this search process, the number of documents to be loaded in the RAG can be narrowed down, and improvement in search accuracy in the RAG can be expected.

### SUMMARY

The Telco-RAG described in Andrei-Laurentiu Bornea etc., “Telco-RAG: Navigating the Challenges of Retrieval Augmented Language Models for Telecommunications”, arXiv:2404.15939v3[cs.IR], Aug. 7, 2024 can be used only for the purpose of creating a document with reference to a specification of a specific series of 3GPP specifications, and there is room for improvement in terms of versatility. In addition, it is possible to improve the accuracy of generation using the reference information even in a generative model other than the LLM, and improvement on the search for the reference information is desired.

An example object of the present disclosure is to provide a technique that contributes to improving search for reference information to be referred to by a generative model.

An information processing apparatus according to an example aspect of the present disclosure includes at least one memory storing instructions and at least one processor configured to execute the instructions to select a reference information database to be searched among a plurality of reference information databases based on an attribute recorded as meta-information of a reference information database in which reference information is recorded, the attribute being common to the reference information recorded in the reference information database, and search for reference information to be referred to by a generative model trained by machine-learning to generate output data according to an input query with the reference information database selected as a target.

An information processing apparatus according to an example aspect of the present disclosure includes at least one memory storing instructions and at least one processor configured to execute the instructions to estimate an attribute common to reference information recorded in a reference information database for the reference information database in which reference information to be referred to by a generative model trained by machine-learning to generate output data according to an input query is recorded, and record the estimate attribute as meta-information of the reference information database.

An information processing method according to an example aspect of the present disclosure causes at least one processor to execute narrow-down processing of selecting a reference information database to be searched among a plurality of reference information databases based on an attribute recorded as meta-information of a reference information database in which reference information is recorded, the attribute being common to the reference information recorded in the reference information database, and search processing of searching for reference information to be referred to by a generative model trained by machine-learning to generate output data according to an input query with the reference information database selected by the narrow-down processing as a target.

According to one example aspect of the present disclosure, there is an exemplary effect that it is possible to provide a technology that contributes to improvement in search for reference information to be referred to by a generative model.

### BRIEF DESCRIPTION OF DRAWINGS

The above and other aspects, features, and advantages of the present disclosure will become more apparent from the following description of certain example embodiments, taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of another information processing apparatus according to the present disclosure;

FIG. 4 is a flowchart illustrating a flow of another information processing method according to the present disclosure;

FIG. 5 is a block diagram illustrating a configuration of another further information processing apparatus according to the present disclosure;

FIG. 6 is a diagram illustrating a construction example of a reference information DB and a generation example of output data using the constructed reference information DB;

FIG. 7 is a flowchart illustrating a flow of processing executed at the time the information processing apparatus illustrated in FIG. 5 constructs the reference information DB;

FIG. 8 is a flowchart illustrating a flow of processing executed at the time the information processing apparatus illustrated in FIG. 5 generates the output data; and

FIG. 9 is a block diagram illustrating a configuration of a computer that functions as the information processing apparatus according to the present disclosure.

### EXAMPLE EMBODIMENT

Hereinafter, example embodiments of the present disclosure will be described. However, the present disclosure is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present disclosure. Example embodiments obtained by appropriately omitting some of the techniques adopted in the following exemplary example embodiments can also be included in the scope of the present disclosure. Effects mentioned in the following exemplary example embodiments are examples of effects expected in the exemplary example embodiments, and do not define extension of the present disclosure. That is, example embodiments that do not achieve the effects mentioned in each of the exemplary example embodiments described below can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described later. An application range of each technique adopted in the present exemplary example embodiment is not limited to the present exemplary example embodiment. That is, each technique adopted in the present exemplary example embodiment can also be adopted in other exemplary example embodiments included in the present disclosure within a range in which no particular technical problem occurs. Furthermore, each technology illustrated in the drawings referred to for describing the present exemplary example embodiment can also be adopted in other exemplary example embodiments included in the present disclosure within a range in which no particular technical problem occurs.

### (Configuration of Information Processing Apparatus 1)

A configuration of an information processing apparatus 1 according to the present exemplary example embodiment will be described with reference to FIG. 1. FIG. 1 is a block diagram illustrating the configuration of the information processing apparatus 1. As illustrated in FIG. 1, information processing apparatus 1 includes an attribute estimation unit 11 and meta-information recording unit 12.

The attribute estimation unit 11 estimates an attribute common to the reference information recorded in a reference information database for the reference information database for recording the reference information to be referred to in the generative model trained by machine-learning to generate output data according to the input query. Hereinafter, the “reference information database” is abbreviated as a “reference information DB”. DB means “Data Base”.

Here, the “query” indicates an instruction to the generative model, and can be rephrased as, for example, “instruction”, “command”, “prompt”, and the like. The “generative model” is a trained model subjected to machine learning to output output data associated with input data. The above generative model can also be referred to as generative Artificial Intelligence (AI) or the like. The output data generated by the generative model described above is any data. For example, the generative model may generate, as the output data, at least one of text data, image data (may be still image data or moving image data.), and voice data.

The “reference information” may be any information that can be referred to by a generative model.

Here, “to be referred to by” means to input the reference information to the generative model in some form. For example, the reference information can be referred to by the generative model by incorporating the reference information in the query and inputting the reference information to the generative model.

The reference information may be recorded in the reference information DB in association with a vectorized reference information, in other words, an embedding vector of the reference information. In this case, the query is converted into an embedding vector at the time an input of the query instructing generation of output data is accepted. Then, similarity between the embedding vector obtained by this conversion and the embedding vector of each piece of reference information recorded in the reference information DB is calculated, and the reference information related to the query is detected from the reference information DB based on the calculated similarity. The output data can be caused to be generated in consideration of the reference information related to the query by causing the generative model to refer to the reference information detected in this manner.

Here, the “attribute” of the reference information means a characteristic, a property, or a feature of the reference information. Therefore, the “attribute” of the reference information can also be rephrased as a “characteristic”, a “property”, a “feature”, or the like of the reference information. A method for estimating the attribute is not particularly limited. Although the details will be described in the second exemplary example embodiment, for example, the attribute estimation unit 11 may estimate the attribute using various types of inference models, or may estimate the attribute using a rule base or the like.

The meta-information recording unit 12 records the attribute estimated by the attribute estimation unit 11 as meta-information of the reference information DB. Here, the “meta-information” is information used for using or managing the reference information recorded in the reference information DB. A recording destination of the meta-information is not particularly limited. For example, the meta-information recording unit 12 may record the meta-information in a storage unit included in the information processing apparatus 1 or may record the meta-information in a storage apparatus outside the information processing apparatus 1.

As described above, the information processing apparatus 1 according to the present exemplary example embodiment adopts a configuration of including an attribute estimation unit 11 for estimating, for a reference information DB for recording reference information to be referred to by a generative model trained by machine-learning to generate output data according to an input query, an attribute common to the reference information recorded in the reference information DB, and a meta-information recording unit 12 for recording the attribute estimated by the attribute estimation unit 11 as meta-information of the reference information DB.

According to the above configuration, the meta-information indicating the attribute common to the reference information recorded in the reference information DB is recorded. Then, by using this meta-information, at the time an input of a query instructing generation of output data is accepted, it is possible to narrow down the reference information DB to be the target of search for the reference information without using a learned NN or the like such as Telco-RAG described in Andrei-Laurentiu Bornea etc., “Telco-RAG: Navigating the Challenges of Retrieval Augmented Language Models for Telecommunications”, arXiv:2404.15939v3[cs.IR], Aug. 7, 2024. Then, in a case where a learned NN or the like is used, it is possible to only perform one-dimensional narrowing down of searching for a specification of a specific series, whereas according to the information processing apparatus 1 using meta-information, for example, it is possible to perform more flexible narrowing-down such as narrowing down using multi-dimensional meta-information. Therefore, according to the information processing apparatus 1, an effect of contributing to improvement in the search for reference information to be referred to by the generative model is obtained.

### (Information Processing Program)

The functions of the information processing apparatus 1 described above can also be achieved by a program. An information processing program according to the present exemplary example embodiment causes a computer to function as an attribute estimation means for estimating, for a reference information DB for recording reference information to be referred to by a generative model trained by machine-learning to generate output data according to an input query, an attribute common to the reference information recorded in the reference information DB, and a meta-information recording means for recording the attribute estimated by the attribute estimation means as meta-information of the reference information DB. According to this information processing program, since flexible narrowing-down can be performed without using a learned NN or the like, an effect of contributing to improvement in the search for reference information to be referred to by the generative model can be obtained.

(flow of Information Processing Method)

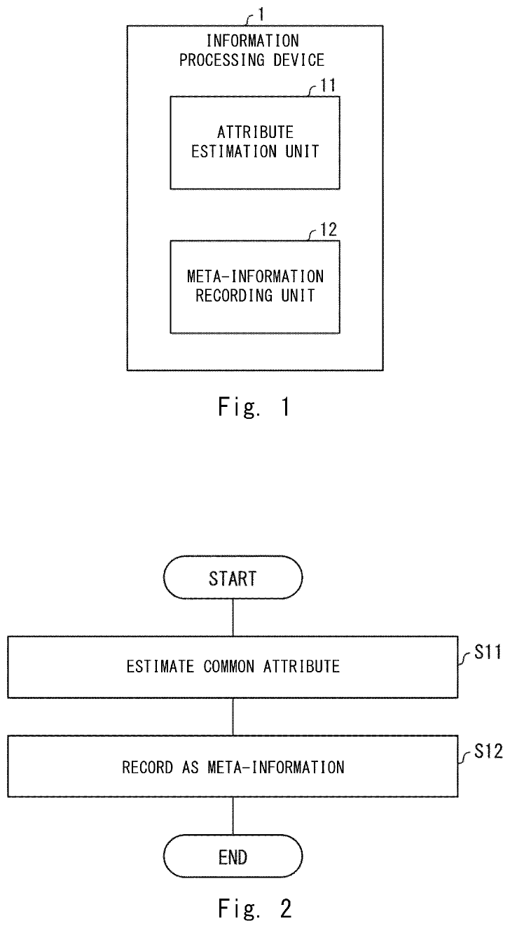

A flow of an information processing method according to the present exemplary example embodiment will be described with reference to FIG. 2. FIG. 2 is a flowchart illustrating the flow of the information processing method. An executing entity of each step in this information processing method may be a processor included in the information processing apparatus 1, may be a processor included in another apparatus, or executing entities of each of the steps may be processors provided in different apparatuses.

In S11 (attribute estimation processing), at least one processor estimates, for a reference information DB for recording reference information to be referred to by a generative model trained by machine-learning to generate output data according to an input query, an attribute common to the reference information recorded in the reference information DB.

In S12 (meta-information recording processing), at least one processor records the attribute estimated in S11 as meta-information of the reference information DB.

As described above, the information processing method according to the present exemplary example embodiment adopts a configuration in which at least one processor executes, for a reference information DB for recording reference information to be referred to by a generative model trained by machine-learning to generate output data according to an input query, attribute estimation processing of estimating an attribute common to the reference information recorded in the reference information DB, and information recording processing of recording the attribute estimated in the attribute estimation processing as meta-information of the reference information DB. According to this information processing method, since flexible narrowing-down can be performed without using a learned NN or the like, an effect of contributing to improvement in the search for reference information to be referred to by the generative model can be obtained.

### (Configuration of Information Processing Apparatus 2)

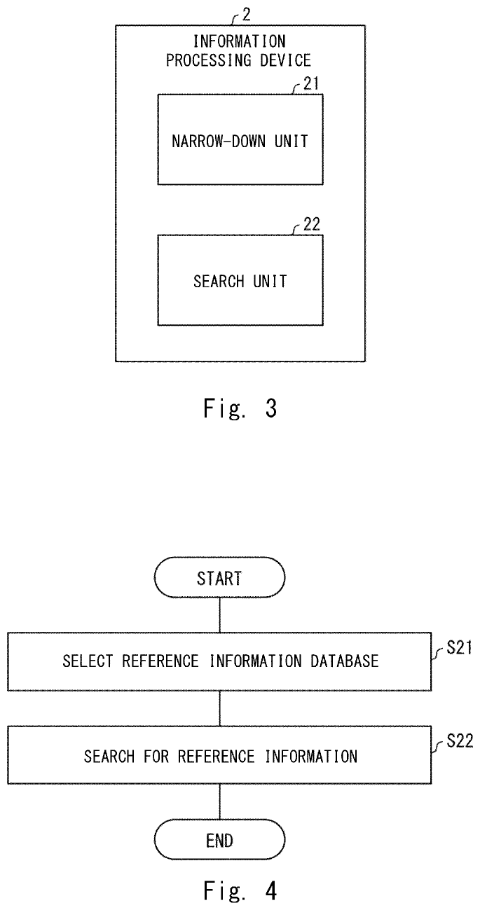

A configuration of the information processing apparatus 2 according to the present exemplary example embodiment will be described with reference to FIG. 3. FIG. 3 is a block diagram illustrating a configuration of the information processing apparatus 2. As illustrated in FIG. 3, the information processing apparatus 2 includes a narrow-down unit 21 and a search unit 22.

The narrow-down unit 21 narrows down the range of search by the search unit 22. More specifically, the narrow-down unit 21 selects one to be searched among the plurality of reference information DBs based on the attribute recorded as the meta-information of the reference information DB in which the reference information is recorded, the attribute being common to the reference information recorded in the reference information DB. The meta-information of the reference information DB may be recorded by the information processing apparatus 1, may be recorded by another apparatus, or may be recorded manually.

In addition, the plurality of reference information DBs may be recorded such that the reference information included in one reference information DB and the reference information included in the other reference information DBs can be identified. For example, the plurality of reference information DBs may be recorded in a plurality of storage apparatuses in a distributed manner, or may be recorded in one storage apparatus.

Here, selecting one to be searched among the plurality of reference information DBs “based on the attribute common to the reference information” means directly or indirectly using the attribute in selecting the reference information DB. For example, the narrow-down unit 21 may select the reference information DB to be searched using the attribute indicated in the meta-information as it is, or may select the reference information DB to be searched using the analysis result obtained by analyzing the attribute indicated in the meta-information.

The search unit 22 searches for reference information to be referred to by the generative model trained by machine-learning to generate output data according to the input query with the reference information DB selected by the narrow-down unit 21 as the target. The “generative model” described above is a learned model trained by machine-learning to output output data related to input data, similarly to the generative model mentioned in the description of the information processing apparatus 1.

As described above, the information processing apparatus 2 according to the present exemplary example embodiment adopts a configuration including the narrow-down unit 21 for selecting one to be searched among the plurality of reference information DBs based on the attribute recorded as the meta-information of the reference information DB in which the reference information is recorded, the attribute being common to the reference information recorded in the reference information DB, and the search unit 22 for searching for the reference information to be referred to by the generative model trained by machine-learning to generate the output data according to the input query with the reference information DB selected by the narrow-down unit 21 as the target.

According to the above configuration, the reference information DB to be searched for the reference information is selected without using the learned NN or the like, and the search is performed for the selected reference information DB. Therefore, according to the information processing apparatus 2, since it is possible to perform flexible narrowing-down using the meta-information without using the learned NN or the like, an effect of contributing to improvement in the search for reference information to be referred to by the generative model can be obtained. It can also be said that the information processing apparatus 2 contributes to optimization in the search for the reference information.

### (Information Processing Program)

The functions of the information processing apparatus 2 described above can also be achieved by a program. An information processing program according to the present exemplary example embodiment causes a computer to function as a narrow-down means for selecting one to be searched among the plurality of reference information DBs based on the attribute recorded as the meta-information of the reference information DB in which the reference information is recorded, the attribute being common to the reference information recorded in the reference information DB, and the search means for searching for the reference information to be referred to by the generative model trained by machine-learning to generate the output data according to the input query with the reference information DB selected by the narrow-down means as the target. According to the information processing program, since it is possible to perform flexible narrowing-down using the meta-information without using the learned NN or the like, an effect of contributing to improvement in the search for reference information to be referred to by the generative model can be obtained.

### (Flow of Information Processing Method)

A flow of another information processing method according to the present exemplary example embodiment will be described with reference to FIG. 4.

FIG. 4 is a flowchart illustrating a flow of another information processing method. An executing entity of each step in this information processing method may be a processor included in the information processing apparatus 2, may be a processor included in another apparatus, or executing entities of each of the steps may be processors provided in different apparatuses.

In S21 (narrow-down processing), at least one processor selects one to be searched among the plurality of reference information DBs based on the attribute recorded as the meta-information of the reference information DB in which the reference information is recorded, the attribute being common to the reference information recorded in the reference information DB.

In S22 (search processing), at least one processor searches for the reference information to be referred to by the generative model trained by machine-learning to generate the output data according to the input query with the reference information database selected in S21 as the target.

As described above, in another information processing method according to the present exemplary example embodiment, the configuration is adopted in which at least one processor executes the narrow-down processing of selecting one to be searched among the plurality of reference information DBs based on the attribute recorded as the meta-information of the reference information DB in which the reference information is recorded, the attribute being common to the reference information recorded in the reference information DB, and the search processing of searching for the reference information to be referred to by the generative model trained by machine-learning to generate the output data according to the input query with the reference information database selected in the narrow-down processing as the target. According to the information processing method, since it is possible to perform flexible narrowing-down using the meta-information without using the learned NN or the like, an effect of contributing to improvement in the search for reference information to be referred to by the generative model can be obtained.

### Second Exemplary Example Embodiment

A second exemplary example embodiment that is an example of the example embodiments of the present disclosure will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in other exemplary example embodiments included in the present disclosure within a range in which no particular technical problem occurs. Each technique illustrated in each of the drawings referred to for describing the present exemplary example embodiment can be adopted in other exemplary example embodiments included in the present disclosure within the scope in which no particular technical problem occurs.

### (Configuration of Information Processing Apparatus 3)

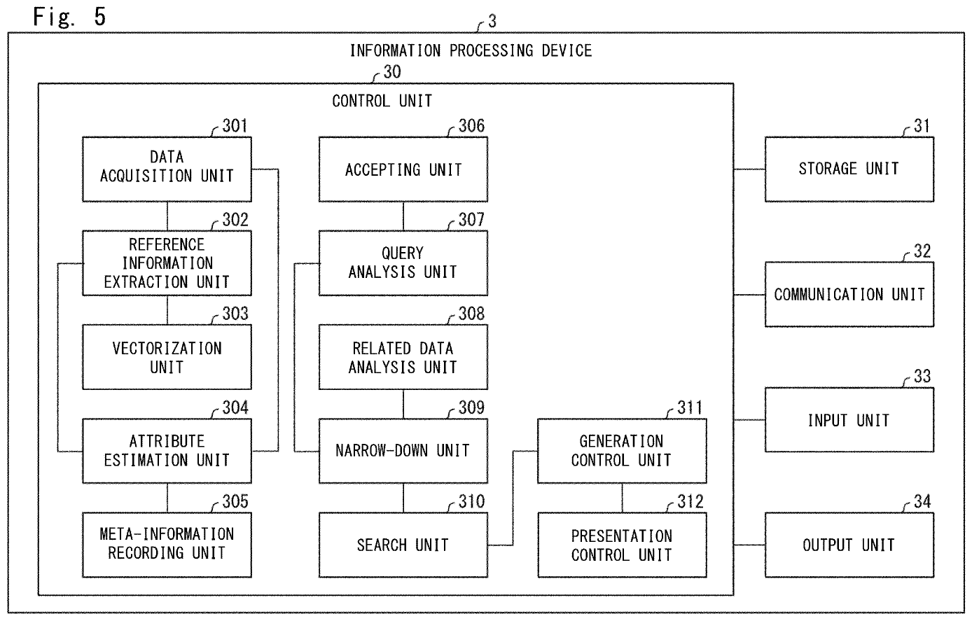

A configuration of an information processing apparatus 3 according to the present exemplary example embodiment will be described with reference to FIG. 5. FIG. 5 is a block diagram illustrating the configuration of the information processing apparatus 3. The information processing apparatus 3 is a apparatus having a function of generating a reference information DB in which reference information to be referred to by the generative model is recorded. In addition, the information processing apparatus 3 also has a function of causing the generative model to generate output data using the reference information described above. The information processing apparatus 3 may be a local apparatus used by individual users, or may be a server that provides a generation service of a reference information DB and a generation service of output data by a generative model to a plurality of users.

Hereinafter, an example of using a generative model M1 as the above-described generative model will be described. The generative model M1 is a language model capable of performing the natural language processing. The language model capable of performing the natural language processing can be generated by learning the arrangement of constituent elements (words etc.) in a sentence of a natural language and the arrangement of a sentence and a sentence in a writing. Examples of the language model capable of performing the natural language processing include Bidirectional Encoder Representations from Transformers (BERT), Robustly optimized BERT approach (RoBERTa), and Efficiently Learning an Encoder that Classifies Token Replacements Accurately (ELECTRA).

As illustrated, the information processing apparatus 3 includes a control unit 30 for comprehensively controlling each unit of the information processing apparatus 3 and a storage unit 31 for storing various types of data used by the information processing apparatus 3. The information processing apparatus 3 includes a communication unit 32 for the information processing apparatus 3 to communicate with another apparatus, an input unit 33 for accepting an input to the information processing apparatus 3, and an output unit 34 for the information processing apparatus 3 to output data. The control unit 30 includes a data acquisition unit 301, a reference information extraction unit 302, a vectorization unit 303, an attribute estimation unit 304, a meta-information recording unit 305, an accepting unit 306, a query analysis unit 307, a related data analysis unit 308, a narrow-down unit 309, a search unit 310, a generation control unit 311, and a presentation control unit 312.

The data acquisition unit 301 acquires various types of data used by the information processing apparatus 3. For example, the data acquisition unit 301 acquires extraction source data that is data to be an extraction source of the reference information. A data acquisition method is not particularly limited. For example, the data acquisition unit 301 may acquire data from an external apparatus via the communication unit 32, or may acquire data input to the information processing apparatus 3 via the input unit 33.

The reference information extraction unit 302 extracts a plurality of elements included in the extraction source data acquired by the data acquisition unit 301 as reference information. In addition, the reference information extraction unit 302 records reference information including a plurality of elements extracted from at least a part of one piece of extraction source data as one database. As a result, the reference information DB in which the reference information including the element having a common attribute of being extracted from the same extraction source data is recorded is constructed.

As a reference information extraction method, any method can be applied as long as it is a method capable of extracting reference information including an element of a volume appropriate for recording in one reference information DB, the reference information having some kind of attribute in common. For example, in a case where the extraction source data is a specification group including product specifications of a plurality of series, the reference information extraction unit 302 may perform, for each series, processing of extracting each sentence included in a product specification of a certain series as reference information and recording the same as a reference information DB related to the series. As a result, a reference information DB in which the reference information having a sentence with a common attribute of series as an element is recorded is constructed. Similarly, a reference information DB in which reference information having a common release timing is recorded or a reference information DB in which reference information having a common stage is recorded can be constructed.

Furthermore, for example, the reference information extraction unit 302 may extract an element described in a specific item in the specification as the reference information. For example, in a case where the reference information extraction unit 302 extracts each element (e.g., sentence) described in an item “communication standard” as reference information and records the extracted element in one reference information DB, a reference information DB in which reference information having a common attribute of being related to a communication standard is recorded is constructed.

The vectorization unit 303 vectorizes the reference information extracted by the reference information extraction unit 302.

In other words, the vectorization unit 303 generates an embedding vector of the reference information extracted by the reference information extraction unit 302. Then, the vectorization unit 303 records the generated embedding vector in association with the original reference information in the reference information DB. Specifically, the vectorization unit 303 inputs each element included in the reference information to a trained by machine-learning embedding model, and generates an embedding vector of each of the elements. As the embedding model, for example, Word2Vec, BERT, or the like can be used. Hereinafter, the embedding model used by the vectorization unit 303 is referred to as an embedding model M2. “Vectorization” can also be rephrased as “encoding” or the like.

Similarly to the attribute estimation unit 11 of the first exemplary example embodiment, the attribute estimation unit 304 estimates, for a reference information DB for recording the reference information to be referred to by the generative model M1 trained by machine-learning to generate output data according to an input query, an attribute common to the reference information recorded in the reference information DB. Although details will be described later, the attribute estimation unit 304 may estimate an attribute common to the reference information using, for example, a language model trained by machine-learning in such a way as to perform natural language processing. Hereinafter, a language model used for estimating an attribute common to the reference information is referred to as a language model M3.

Similarly to the meta-information recording unit 12 of the first exemplary example embodiment, the meta-information recording unit 305 records the attribute estimated by the attribute estimation unit 304 as the meta-information of the reference information DB.

The accepting unit 306 accepts an input of a query instructing generation of output data. A method for accepting the input is not particularly limited. For example, the accepting unit 306 may accept an input of a query from an external apparatus via the communication unit 32, or may accept an input of a query via the input unit 33.

The query analysis unit 307 estimates the attribute of the query accepted by the accepting unit 306 by using a language model trained by machine-learning in such a way as to perform natural language processing. Hereinafter, the language model used for estimating the attribute of the query is referred to as a language model M4.

The related data analysis unit 308 estimates an attribute of related data that is data used in a predetermined project to be proceeded using the output data output from the generative model M1. For example, the related data analysis unit 308 may estimate the attribute of the related data by using a language model trained by machine-learning in such a way as to perform natural language processing. Hereinafter, the language model used for estimating the attribute of the related data is referred to as a language model M5. Details of the project and the related data will be described later.

Similarly to the narrow-down unit 21 of the first exemplary example embodiment, the narrow-down unit 309 selects some of the plurality of reference information DBs based on an attribute recorded as the meta-information for each of the plurality of reference information DBs in which the reference information is recorded, the attribute being common to the reference information recorded in the reference information DB. The meta-information of the reference information DB is recorded by the meta-information recording unit 305 as described above.

Similarly to the search unit 22 of the first exemplary example embodiment, the search unit 310 searches for the reference information to be referred to by the generative model M1 with the reference information DB selected by the narrow-down unit 309 as the target. More specifically, the search unit 310 first converts the query accepted by the accepting unit 306 into an embedding vector by using the embedding model M2. Next, the search unit 310 calculates similarity between the embedding vector obtained by the conversion and the embedding vector of each piece of reference information recorded in the reference information DB. Then, the search unit 310 acquires the reference information related to the query from the reference information DB based on the calculated similarity. For example, the search unit 310 may acquire reference information of which the similarity is equal to or greater than a predetermined threshold value, or may acquire a predetermined number of pieces of reference information of which the similarity is high. In a case where the narrow-down unit 309 selects a plurality of reference information DBs, the search unit 310 may acquire the reference information from each of the selected reference information DBs.

The generation control unit 311 causes the generative model M1 to generate output data related to the query accepted by the accepting unit 306. At this time, the generation control unit 311 causes the generative model M1 to refer to the reference information detected by the search unit 310.

A method for causing the generative model M1 to refer to the reference information detected by the search unit 310 is not particularly limited. For example, the generation control unit 311 may generate a new query by incorporating the reference information detected by the search unit 310 into the query accepted by the accepting unit 306, and input the generated new query to the generative model M1 to cause output data to be generated. As a result, in addition to the effect obtained by the information processing apparatus 2, an effect that output data reflecting the reference information detected by the search unit 310 can be generated by one query can be obtained.

The presentation control unit 312 performs processing of presenting various types of information to the user. For example, the presentation control unit 312 presents the output data generated by the generative model M1 to the user under the control of the generation control unit 311. A mode of presentation of the information by the presentation control unit 312 is any mode. For example, the presentation control unit 312 may present information to the user by causing a display apparatus to display and output the information or may present information to the user by causing a voice output apparatus to output the information by voice. The apparatus for outputting information may be a apparatus included in the information processing apparatus 3 (e.g., the output unit 34) or a apparatus external to the information processing apparatus 3 (e.g., a terminal apparatus or the like possessed by the user).

### (Method for Estimating Attribute by Attribute Estimation Unit)

As described above, the attribute estimation unit 304 estimates the attribute common to the reference information recorded in the reference information DB (more precisely, the attribute common to each element included in the reference information). Hereinafter, a method for estimating the attribute by the attribute estimation unit 304 will be described.

For example, as described above, the attribute estimation unit 304 may input the reference information recorded in the reference information DB to the language model M3 trained by machine-learning in such a way as to perform natural language processing, and cause the attribute common to the reference information to be estimated. As a result, in addition to the effect obtained by the information processing apparatus 1, an effect of accurately estimating the attribute common to the reference information can be obtained.

For example, the attribute estimation unit 304 may generate a query instructing estimation of an attribute by using a template of “please answer by selecting appropriate one from the following list as an attribute common to the following information. [Information] [List]”. In this case, the attribute estimation unit 304 inputs each element included in the reference information recorded in the reference information DB to the portion of [Information] in the template, and inputs an attribute candidate to be recorded as the meta-information of the reference information DB to the portion of [List], thereby generating a query instructing estimation of the attribute. Then, the attribute estimation unit 304 can cause the estimation result of the attribute to be output by inputting the generated query to the language model M3. It is not essential to designate an attribute candidate. For example, the attribute estimation unit 304 may cause the language model M3 to generate a keyword representing an attribute common to the reference information.

In addition, as described above, information extracted from one piece of extraction source data may be recorded as reference information in one reference information DB. In this case, the attribute estimation unit 304 may estimate the attribute of the extraction source data as the attribute of the reference information extracted from the extraction source data. As a result, in addition to the effect obtained by the information processing apparatus 1, an effect of obtaining an accurate attribute estimation result by simple processing can be obtained.

The attribute of the extraction source data can be specified from, for example, meta-information of the extraction source data. For example, in a case where the extraction source data is a specification of a certain product, information such as a version of the specification and a target product, or the like is recorded as meta-information. In this case, the attribute estimation unit 304 can estimate the attributes indicated in these pieces of information as the attributes of the reference information. Furthermore, a method for determining the attribute of the extraction source data is arbitrary, and for example, the attribute may be determined by a language model or the like, or may be determined manually.

In the reference information DB, information extracted from extraction source data generated by a predetermined project may be recorded as the reference information. In this case, the attribute estimation unit 304 may estimate the attribute of the project as the attribute of the reference information extracted from the extraction source data. As a result, in addition to the effect obtained by the information processing apparatus 1, an effect of obtaining an accurate attribute estimation result by simple processing can be obtained.

The “project” means a series of activities or works performed to achieve a specific purpose. Furthermore, the attribute of the project can be specified from, for example, meta-information of the project. Moreover, a method for determining the attribute of the project is arbitrary, and for example, the attribute may be determined by a language model or the like, or may be determined manually. Specific examples of the attribute of the project include, for example, a technical field, a purpose, a product, an application of the product, or the like.

For example, in a case where the information processing apparatus 3 is used in a project of creating content (e.g., specification) including a series of a plurality of documents, content generated in a similar project in the past may be used as the extraction source data. In this case, the attribute estimation unit 304 may estimate the attribute of the past project as the attribute of the reference information extracted from the content (extraction source data) generated in the project.

The above-described estimation method is merely an example, and the method for estimating the attribute by the attribute estimation unit 304 is not limited to the following example. For example, for each attribute candidate, a condition for applying the candidate may be determined in advance. In this case, the attribute estimation unit 304 may estimate a candidate related to a condition satisfied by each element included in the reference information DB as an attribute common to each element included in the reference information DB. For example, an application condition that any term included in a specific term group used in 3GPP is included for the attribute “3GPP” may be determined in advance. As a result, the attribute estimation unit 304 can estimate the attribute of the reference information in which each element includes a specific term used in 3GPP as “3GPP”. In this manner, it is also possible to estimate the attribute by a rule-based method.

### (Method of Narrowing Down Reference Information DB by Narrow-Down Unit)

As described above, the narrow-down unit 309 selects the reference information DB to be searched based on the meta-information recorded for each of the plurality of reference information DBs. For example, the narrow-down unit 309 may select the reference information DB based on the estimation result of the attribute by the query analysis unit 307 for the query accepted by the accepting unit 306 and the meta-information recorded for each of the plurality of reference information DBs. As a result, in addition to the effect obtained by the information processing apparatus 2, an effect is obtained in that the reference information related to the query accepted by the accepting unit 306 can be reflected on the output data generated by the generative model M1 based on the query.

For example, the query analysis unit 307 may generate a query instructing estimation of the attribute by using a template of “Please select appropriate one as attribute of following query from the following list and answer. [Query] [List]”. In this case, the query analysis unit 307 can generate a query instructing estimation of the attribute by inputting the query accepted by the accepting unit 306 to the portion of [Query] in the template and inputting each attribute indicated in the meta-information of the reference information DB to the portion of [List]. Then, the query analysis unit 307 can output the estimation result of the attribute by inputting the generated query to the language model M4.

Here, the query generated using the template instructs to select the attribute of the query from among the attributes indicated in the meta-information of the reference information DB. In a case where the query analysis unit 307 estimates the attribute of the query using such a query, the narrow-down unit 309 may select the reference information DB associated with the meta-information indicating the same attribute as the query. For example, it is assumed that an attribute “related to hardware of communication apparatus” is recorded as meta-information of a certain reference information DB, and an attribute “related to software of communication apparatus” is recorded as meta-information of another reference information DB. In this case, if the estimated attribute of the query is “related to hardware of communication apparatus”, the narrow-down unit 309 may select the reference information DB in which the attribute “related to hardware of communication apparatus” is recorded as the meta-information. In this case, if the estimated attribute of the query is “related to software of communication apparatus”, the narrow-down unit 309 may select the reference information DB in which the attribute “related to software of communication apparatus” is recorded as the meta-information.

However, it is not essential to select the attribute of the query from among the attributes indicated in the meta-information of the reference information DB. In a case where the attribute indicated in the meta-information of the reference information DB does not completely match the attribute estimated by the query analysis unit 307, the narrow-down unit 309 may select the reference information DB to which the meta-information indicating the attribute related to the attribute estimated by the query analysis unit 307 is added. Whether the attributes are related to each other can be determined based on, for example, similarity calculated by converting each attribute into an embedding vector. Furthermore, the narrow-down unit 309 can also cause the language model to determine whether the attributes are related to each other. Furthermore, the narrow-down unit 309 can also cause the language model to perform processing of selecting the reference information DB to which the meta-information indicating the attribute related to the attribute estimated by the query analysis unit 307 is added.

Furthermore, the narrow-down unit 309 may select the reference information DB based on the meta-information recorded for each of the plurality of reference information DBs and the attribute of the predetermined project to be proceeded using the output data output from the generative model M1. As a result, in addition to the effect obtained by the information processing apparatus 2, an effect is obtained in that an appropriate reference information DB related to the project can be selected.

The attribute of the project may be recorded in advance as, for example, setting data or meta-information of the project. As described above, the method for determining the attribute of the project is arbitrary, and may be determined by a language model or the like, or may be determined manually. For example, the narrow-down unit 309 may estimate the attribute of the project by analyzing a sentence, an image, or the like describing the project using a language model or the like.

In addition, as described above, the information processing apparatus 3 includes the related data analysis unit 308 for estimating the attribute of the related data used in a predetermined project to be proceeded using the output data output from the generative model M1. Therefore, the narrow-down unit 309 may select the reference information DB based on the meta-information recorded for each of the plurality of reference information DBs and the estimation result of the related data analysis unit 308. As a result, in addition to the effect obtained by the information processing apparatus 2, an effect is obtained in that an appropriate reference information DB can be selected in consideration of the attribute of the related data.

The related data may be data used in a predetermined project that is proceeded using the output data output from the generative model M1. For example, in the case of a project to be proceeded using a plurality of data files, the data file group may be set as the related data. This data file group may include, for example, at least one of a data file to be edited in a project and a data file not to be edited but to be referred to. Furthermore, for example, in a case where the information processing apparatus 3 is used in a project for generating predetermined content using output data output from the generative model M1, the content in the middle of being created (edited) may be used as related data.

The usage mode of the generative model M1 in the generation of the content is arbitrary. For example, a direct use of causing the generative model M1 to generate a part or all of the content is possible. In addition, an indirect use of causing the generative model M1 to generate an answer to a question related to generation of a content, and generating the content manually with reference to the answer is also possible.

Furthermore, for example, in a case where the information processing apparatus 3 is used in a project of creating contents (e.g., specification) including a series of a plurality of documents, the output data of the generative model M1 may be used for generation of one of the plurality of documents. In this case, the rest of the plurality of documents (may be a document that has been created or a document that is being created) may be set as the related data. In addition, material data to be a constituent element of the document, data indicating conditions to be satisfied by the document, data used as a reference in creating the document, and the like may be set as the related data.

The related data analysis unit 308 may estimate attributes in advance for invariable related data regardless of the degree of progress of the project and record the estimation result. On the other hand, for related data (e.g., a document in the middle of being created, etc.) whose content changes depending on the degree of progress of the project, the related data analysis unit 308 preferably estimates the attribute at a timing the change in the content is reflected on the estimation result. For example, the related data analysis unit 308 may estimate the attribute of the related data after the accepting unit 306 accepts the input of the query.

As described above, the narrow-down unit 309 can narrow down the reference information DB by various methods. In addition, the narrow-down unit 309 may narrow down the reference information DB by using a plurality of methods together. As a result, narrowing down can be performed from multifaceted viewpoints, and even in a case where it is difficult to perform effective narrowing down with some methods, the insufficiency can be covered with other methods. For example, in a case where the sentence of the query is short, it is difficult to perform accurate narrowing down based only on the analysis result of the query. However, even in such a case, it is possible to perform an accurate narrowing down in view of the context of the query by using the attribute of the project and/or the related data analysis result.

### (Construction Example of Reference Information DB and Generation Example of Output Data Using Constructed Reference Information DB)

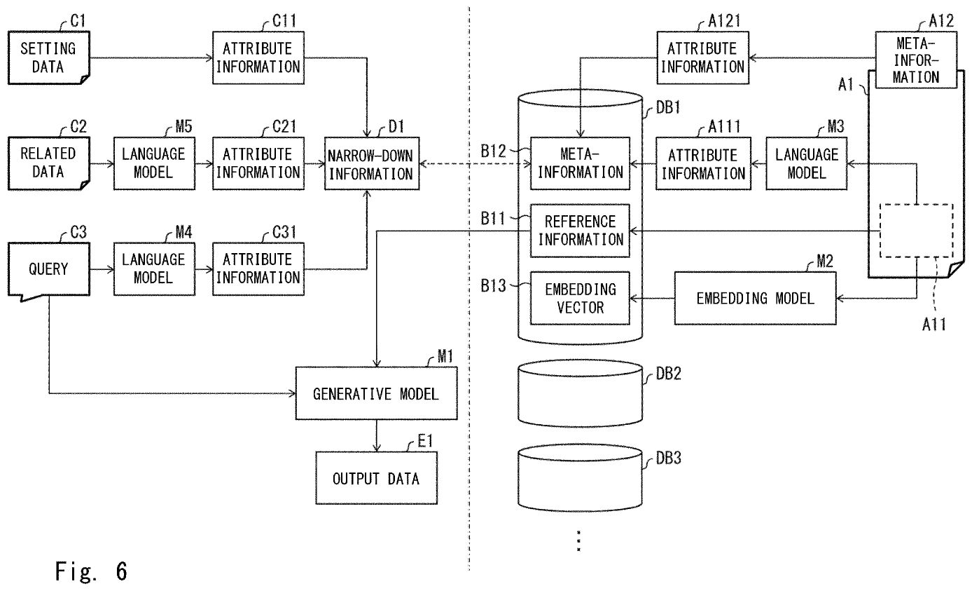

FIG. 6 is a diagram illustrating a construction example of the reference information DB by the information processing apparatus 3 and a generation example of output data using the constructed reference information DB. In FIG. 6, the right side of an alternate long and short dash line drawn in the vertical direction near the center shows a construction example of the reference information DB, and the left side of the alternate long and short dash line shows a generation example of the output data. Hereinafter, first, a construction example of the reference information DB will be described, and subsequently, a generation example of the output data will be described.

### (Construction Example of Reference Information DB)

FIG. 6 illustrates an example in which the reference information is extracted from the extraction source data A1. The extraction source data A1 is acquired by the data acquisition unit 301. For example, the extraction source data A1 may be content such as a specification created in a predetermined project performed in the past. A plurality of pieces of extraction source data may be acquired, in which case, one reference information DB may be constructed from one extraction source data, or a plurality of reference information DBs may be constructed from one extraction source data.

Furthermore, in the example of FIG. 6, partial data A11 that is a part of the extraction source data A1 is extracted from the extraction source data A1, and the reference information DB1 in which the extracted partial data A11 is recorded as the reference information B11 is constructed. Processing of extracting the partial data A11 and recording the extracted partial data as the reference information B11 is performed by the reference information extraction unit 302. For example, in a case where the extraction source data A1 is document data, the reference information extraction unit 302 may sectionalize the extraction source data A1 into groups of meanings such as a chapter, a clause, or a paragraph, and extract one of the sections as the partial data A11. Furthermore, the reference information extraction unit 302 may mechanically sectionalize the extraction source data A1 by a page, the number of characters, or the like, and extract one of the sections as the partial data A11. In these cases, each sentence included in the partial data A11 is a constituent element of the reference information B11. Although not illustrated in FIG. 6, the reference information is also extracted from a portion other than the partial data A11 in the extraction source data A1.

The partial data A11 extracted from the extraction source data A1 is input to the embedding model M2. Then, the output from the embedding model M2 is recorded in the reference information DB1 as the embedding vector B13. The embedding vector B13 is generated and recorded by the vectorization unit 303. More precisely, the vectorization unit 303 inputs each element (e.g., a sentence) included in the partial data A11 to the embedding model M2 and generates an embedding vector of each element. Then, the vectorization unit 303 records the generated embedding vector in association with the corresponding element.

The partial data A11 extracted from the extraction source data A1 is also input to the language model M3. Each element included in the partial data A11 is collectively input to the language model M3, and an instruction is given to estimate an attribute common to these elements. Then, the attribute information A111 indicating the attribute estimation result is output from the language model M3, and the output attribute information A111 is recorded in the reference information DB1 as the meta-information B12. The processing of generating the attribute information A111 is performed by the attribute estimation unit 304, and the processing of recording the attribute information A111 as the meta-information B12 is performed by the meta-information recording unit 305.

In the example of FIG. 6, the meta-information A12 is associated with extraction source data A1. The attribute information A121 of the extraction source data A1 indicated in the meta-information A12 is also recorded in the reference information DB1 as the meta-information B12. That is, in the example of FIG. 6, the attribute estimation unit 304 estimates that the attribute of the extraction source data A1 indicated in the attribute information A121 is an attribute common to the reference information B11 (more precisely, an attribute common to each element included in the reference information B11). The meta-information recording unit 305 records the estimation result as meta-information B12.

Although not illustrated in FIG. 6, in a case where the extraction source data A1 is content created in a predetermined project performed in the past, the attribute estimation unit 304 may estimate the attribute of the project as the attribute of the reference information B11 (more precisely, an attribute common to each element included in the reference information B11). A result of such estimation is also recorded as the meta-information B12.

Through the above processing, the reference information DB1 in which the reference information B11 and the embedding vector B13 are recorded is constructed, and the meta-information B12 of the reference information DB1 is recorded. In addition, the reference information is similarly extracted from the other portions of the extraction source data A1 to construct the reference information DB, and the embedding vector of the reference information recorded in the reference information DB and the meta-information of the reference information DB are generated and recorded. FIG. 6 illustrates the reference information DB2 and the reference information DB3 as another example of the constructed reference information DB. The number of reference information DBs to be constructed is related to the number, volume, content, and the like of the extraction source data. As described above, the plurality of reference information DBs may be recorded such that the reference information included in one reference information DB and the reference information included in another reference information DB can be identified. For example, a table including each piece of information recorded in the reference information DB1, a table including each piece of information recorded in the reference information DB2, and a table including each piece of information recorded in the reference information DB3 may be recorded in one DB, and each table may be treated as a different reference information DB.

### (Generation Example of Output Data)

FIG. 6 illustrates an example in which a query C3 instructing generation of predetermined output data related to a predetermined project is input to the information processing apparatus 3. The query C3 may be, for example, an instruction to generate a part of the content generated in the project, a question asking for an answer to information (e.g., an old specification of a product indicated in the content, etc.) or the like necessary for generating the content. In the former case, the output data E1 generated by the generative model M1 is a part of the content. On the other hand, in the latter case, the output data E1 generated by the generative model M1 is an answer to the question.

In the example of FIG. 6, in order to narrow down the reference information DB used in the generation of the output data E1, the setting data C1 indicating the setting of the project and the related data C2 related to the project are used in addition to the query C3.

The setting data C1 includes attribute information C11 indicating the attribute of the project.

It can be said that the setting data C1 is meta-information of the project. In the example of FIG. 6, the narrow-down unit 309 acquires the attribute information C11 included in the setting data C1 as the narrow-down information D1 used for narrowing down the reference information DB. For example, in a case where the keyword representing the project is included in the setting data C1, the narrow-down unit 309 may acquire the keyword as the attribute information C11. Furthermore, for example, the setting data C1 may be data such as a sentence or an image describing the project. In this case, the narrow-down unit 309 may analyze the setting data C1 by inputting the setting data C1 to the language model or the like to acquire the attribute information C11.

In the example of FIG. 6, the related data C2 is input to the language model M5, and the attribute information C21 indicating the estimation result of the attribute of the related data C2 is output from the language model M5. For example, the related data C2 may be a data file group used in the project. The related data C2 is analyzed by the related data analysis unit 308. Then, the narrow-down unit 309 also acquires the attribute information C21 as the narrow-down information D1 similarly to the attribute information C21.

Furthermore, in the example of FIG. 6, the query C3 is input to the language model M4, and the attribute information C31 indicating the estimation result of the attribute of the query C3 is output from the language model M4. The query C3 is analyzed by the query analysis unit 307. Then, the narrow-down unit 309 also acquires the attribute information C31 as the narrow-down information D1 similarly to the attribute information C11 and C21.

The narrow-down unit 309 that has acquired the attribute information C11, C21, and C31 as the narrow-down information D1 as described above selects the reference information DB to be searched by the search unit 310 from the plurality of reference information DBs including the reference information DB1 to DB3 using the narrow-down information D1.

In the example of FIG. 6, the reference information DB1 is selected. Therefore, the search unit 310 searches for information related to the query C3 from the reference information B11 recorded in the reference information DB1.

As described above, at the time of searching, generation of the embedding vector of the query C3 and calculation of the similarity between the generated embedding vector and the embedding vector B13 related to each element included in the reference information B11 are performed, and one or a plurality of elements included in the reference information B11 are detected based on the calculated similarity. Then, the generation control unit 311 inputs the elements detected by the search unit 310 to the generative model M1 together with the query C3 to generate the output data E1.

Although the language models M3 to M5 are illustrated as different models in FIG. 6, one language model may be used for a plurality of applications. In addition, in a case where the language model is used as the generative model M1, the language model used for generating the output data E1 may be used for other applications.

### (Flow of Processing: Construction of Reference Information DB)

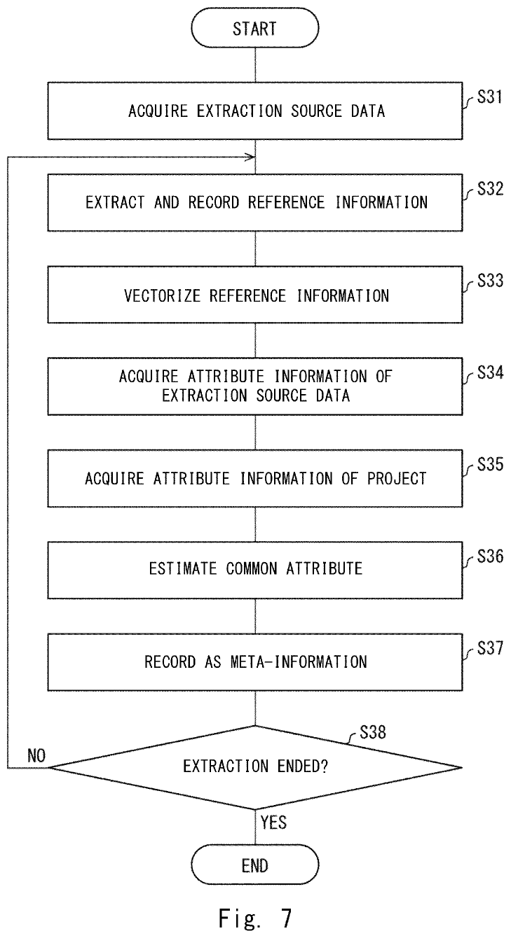

A flow of processing executed by the information processing apparatus 3 at the time of constructing the reference information DB will be described with reference to FIG. 7. FIG. 7 is a flowchart illustrating a flow of processing executed by the information processing apparatus 3 at the time of constructing the reference information DB. The flowchart of FIG. 7 includes each processing of the information processing method of the present exemplary example embodiment.

In S31, the data acquisition unit 301 acquires the extraction source data. Next, in S32, the reference information extraction unit 302 extracts reference information from the extraction source data acquired in S31, records the extracted reference information, and constructs the reference information DB. As described above, the reference information extracted from the extraction source data includes a plurality of elements (e.g., sentences), and each of the elements is recorded.

In S33, the vectorization unit 303 vectorizes the reference information extracted in S32 to generate an embedding vector. As described above, since the reference information includes a plurality of elements, an embedding vector is generated for each element of the reference information in S33. The generated embedding vector is recorded in the reference information DB constructed by the processing of S32.

In S34, the attribute estimation unit 304 acquires the attribute information of the extraction source data acquired in S31. In addition, in S35, the attribute estimation unit 304 acquires attribute information indicating the attribute of the project that has generated the extraction source data acquired in S31. The processing of S35 may be performed before S34, or the processing of S34 and the processing of S35 may be performed in parallel.

In S36 (attribute estimation processing), the attribute estimation unit 304 estimates an attribute common to the reference information extracted in S32. For example, the attribute estimation unit 304 may estimate the attributes indicated in the attribute information acquired in S34 and S35 as attributes common to the reference information extracted in S32.

Furthermore, the attribute estimation unit 304 may input the reference information extracted in S32 to the language model M3 to estimate an attribute common to the reference information. In this case, the attribute estimation unit 304 may estimate the attribute indicated in the estimation result of the language model M3 and the attribute indicated in the attribute information acquired in S34 and S35 as attributes common to the reference information extracted in S32. It is not always necessary to perform all of the estimation by the language model M3, the processing of S34, and the processing of S35, and only a part of these processes may be executed.

In S37 (meta-information recording processing), the meta-information recording unit 305 records the attribute estimated in S36 as meta-information of the reference information DB.

In S38, the reference information extraction unit 302 determines whether to end the extraction of the reference information from the extraction source data acquired in S31. A condition for ending the extraction may be defined in advance. For example, in S38, the reference information extraction unit 302 may determine to end the extraction if the extraction of the reference information from all the portions of the extraction source data acquired in S31 is completed (YES in S38), and determine to continue the extraction if there is a portion for which the extraction of the reference information is not completed (NO in S38).

In a case where determination is made as NO in S38, the processing returns to S32. In S32 proceeded from S38, the reference information extraction unit 302 extracts the reference information with a portion of the extraction source data acquired in S31 for which extraction of the reference information has not been completed as the target. On the other hand, in a case where determination is made as YES in S38, the processing of FIG. 7 ends. Through the above processing, the reference information DB related to each portion of the extraction source data acquired in S31 is constructed.

### (Flow of Processing: Generation of Output Data)

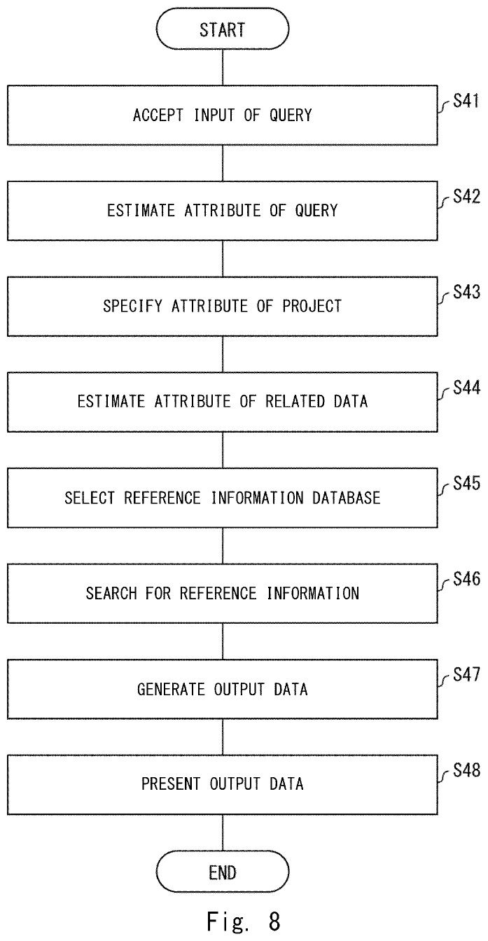

A flow of processing executed by the information processing apparatus 3 at the time of generating output data will be described with reference to FIG. 8. FIG. 8 is a flowchart illustrating a flow of processing executed by the information processing apparatus 3 at the time of generating output data. FIG. 8 illustrates an example of generating output data used to proceed a predetermined project. The flowchart of FIG. 8 includes each processing of the information processing method of the present exemplary example embodiment.

In S41, the accepting unit 306 accepts an input of a query instructing generation of output data. Next, in S42, the query analysis unit 307 estimates the attribute of the query accepted in S41 using the language model M4.

In S43, the narrow-down unit 309 specifies the attribute of the project. For example, the narrow-down unit 309 may specify the attribute of the project by referring to the setting data or meta-information of the project, or may specify the attribute of the project by analyzing data on which the attribute of the project is reflected such as explanatory materials of the project.

In S44, the related data analysis unit 308 estimates the attribute of the related data used in the project. The order of the processing of S42 to S44 is arbitrary. Furthermore, these processes may be performed in parallel. In addition, it is not always necessary to execute all of S42 to S44, and only part of these processes may be executed.

In S45 (narrow-down processing), the narrow-down unit 309 selects some of the plurality of reference information DBs based on the attribute recorded as the meta-information for each of the plurality of reference information DBs, the attribute being common to the reference information recorded in the reference information DB. More specifically, the narrow-down unit 309 selects the reference information DB using the attribute recorded as the meta-information for each of the plurality of reference information DBs to be selected, the attribute of the query estimated in S42, the attribute of the project specified in S43, and the attribute of the related data estimated in S44.

For example, the narrow-down unit 309 may select a reference information DB in which an attribute that is the same as or relates to the attribute of the query estimated in S42 is recorded in the meta-information. In addition, the narrow-down unit 309 may also select a reference information DB in which the attribute that is the same as or relates to the attribute of the project specified in S43 is recorded in the meta-information and a reference information DB in which the attribute that is the same as or relates to the attribute of the related data estimated in S44 is recorded in the meta-information. Through these processes, the reference information DB related to the attribute of the query, the reference information DB related to the attribute of the project, and the reference information DB related to the attribute of the related data are selected.

In S46 (search processing), the search unit 310 acquires the reference information to be referred to by the generative model M1 from the reference information DB selected in S45. Next, in S47, the generation control unit 311 causes the generative model M1 to refer to the reference information acquired in S46 to cause the generative model to generate output data related to the query accepted in S41. Then, in S48, the presentation control unit 312 presents the output data generated in S47. As a result, the processing in FIG. 8 ends. After S47, the processing may return to S41 to accept an input of a new query.

### Regarding Setting of Priority in Selection of Reference Information DB

As described above, the narrow-down unit 309 can select each of the reference information DB related to the attribute of the query, the reference information DB related to the attribute of the project, and the reference information DB related to the attribute of the related data. In this manner, in a case where the reference information DB is narrowed down using a plurality of pieces of information, priority may be given to each piece of information.

For example, an upper limit may be set to the number of reference information DBs to be selected for each piece of information to be used for narrowing down. For example, the upper limit of the reference information DB related to the attribute of the query may be set to 3, the upper limit of the reference information DB related to the attribute of the project may be set to 2, and the upper limit of the reference information DB related to the attribute of the related data may be set to 1. As a result, the output data reflecting the reference information related to the query can be easily generated.

Furthermore, for example, a weight to be multiplied to the similarity of the embedding vector may be set for each piece of information used for narrowing down. For example, the weight with respect to the similarity for the reference information recorded in the reference information DB related to the attribute of the query may be set to 1.5, the weight with respect to the similarity for the reference information recorded in the reference information DB related to the attribute of the project may be set to 1.0, and the weight with respect to the similarity for the reference information recorded in the reference information DB related to the related data attribute may be set to 0.5. In this case, the search unit 310 calculates similarity between the embedding vector of each element of the reference information recorded in the reference information DB and the embedding vector of the query, and multiplies the calculated similarity by the weight. Then, the search unit 310 acquires the reference information based on the similarity multiplied by the weight. As a result, the output data reflecting the reference information related to the query can be easily generated, and the output data reflecting the reference information related to the related data can be less likely to be generated.

The weight and the priority may be set in advance. For example, the reference information DB related to the attribute of the project may have the top priority, the reference information DB related to the attribute of the related data may have the next priority, and the priority of the reference information DB related to the attribute of the query may be the lowest. Furthermore, the weight and the priority may be set and changed by the user.

### Application Example to Medical and Healthcare Field

The information processing apparatus 3 can also be used in the fields of medical and healthcare. For example, according to the information processing apparatus 3, a reference information DB in which knowledge and information regarding each disease are recorded as reference information for each disease can be constructed, and information indicating the disease can be recorded as the meta-information. Then, according to the information processing apparatus 3, in a case where the input of the query requesting to answer the question about the disease is accepted, the reference information DB in which the information indicating the disease is recorded as the meta-information is set as the target of search, and the information regarding the disease can be detected. As a result, the information processing apparatus 3 can generate and present an accurate answer according to the target disease.

### Modified Examples

An executing entity of each processing described in the above-described exemplary example embodiments is optional, and is not limited to the above-described examples. For example, a system having a function similar to that of the information processing apparatuses 1 to 3 can be constructed by a plurality of apparatuses capable of communicating with each other. Furthermore, the executing entity of each processing illustrated in the flowcharts of FIGS. 7 and 8 may be one apparatus (also referred to as a processor) or a plurality of apparatuses (also referred to as processors).

### Implementation Example by Software

Some or all of the functions of the information processing apparatuses 1 to 3 (hereinafter, also referred to as “each of the above apparatuses”) may be achieved by hardware such as an integrated circuit (IC chip) or may be achieved by software.

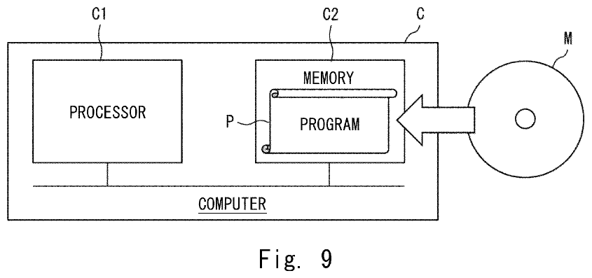

In the latter case, each of the above apparatuses is achieved by, for example, a computer that executes commands of a program that is software for achieving each function. FIG. 9 illustrates an example of such a computer (hereinafter, referred to as a computer C). FIG. 9 is a block diagram illustrating a hardware configuration of the computer C functioning as each of the above apparatuses.

The computer C includes at least one processor C1 and at least one memory C2. A program (information processing program) P for operating the computer C as each of the above apparatuses is recorded in the memory C2. In the computer C, by the processor C1 reading the program P from the memory C2 and executing the program P, each function of each of the above apparatuses is implemented.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination of these can be used. As the memory C2, for example, a flash memory, a Hard Disk Drive (HDD), a Solid State Drive (SSD), or a combination of these can be used.

The computer C may further include a Random Access Memory (RAM) for expanding the program P at the time of execution and temporarily storing various types of data. The computer C may further include a communication interface for transmitting and receiving data to and from another apparatus. The computer C may further include an input/output interface for connecting input/output equipment such as a keyboard, a mouse, a display, or a printer.

The program P can be recorded on a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

The program P can be stored and provided to a computer using any type of non-transitory computer readable media M. Non-transitory computer readable media M include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM, etc.). The program P may be provided to the computer C using any type of transitory computer readable media. Examples of transitory computer readable media include electric signals, optical signals, and electromagnetic waves. Transitory computer readable media can provide the program P to the computer C via a wired communication line (e.g. electric wires, and optical fibers) or a wireless communication line.

Each of the above functions of each of the above apparatuses may be achieved by a single processor provided in a single computer, may be achieved in cooperation with a plurality of processors provided in a single computer, or may be achieved in cooperation with a plurality of processors respectively provided in a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories respectively provided in a plurality of computers.

### Supplementary Information A

The present disclosure includes the techniques described in the following supplementary notes. However, the present disclosure is not limited to the techniques described in the following supplementary notes, and various modifications can be made within the scope described in the claims.

### Supplementary Note A1

An information processing apparatus including
a narrow-down means for selecting a reference information database to be searched among a plurality of reference information databases based on an attribute recorded as meta-information of a reference information database in which reference information is recorded, the attribute being common to the reference information recorded in the reference information database, and
a search means for searching for reference information to be referred to by a generative model trained by machine-learning to generate output data according to an input query with the reference information database selected by the narrow-down means as a target.

### Supplementary Note A2

The information processing apparatus according to supplementary note A1, further including
an accepting means for accepting an input of a query instructing generation of output data, and
a generation control means for generating a new query by incorporating the reference information detected by the search means into the query accepted by the accepting means, and inputting the generated new query to the generative model to cause output data to be generated.

### Supplementary Note A3

The information processing apparatus according to supplementary note A2, further including a query analysis means for estimating an attribute of the query accepted by the accepting means by using a language model trained by machine-learning in such a way as to perform natural language processing,
in which the narrow-down means selects a reference information database to be searched based on the meta-information recorded for each of a plurality of reference information databases and an estimation result of the query analysis means.

### Supplementary Note A4

The information processing apparatus according to supplementary note A2 or A3, in which the narrow-down means selects a reference information database to be searched based on the meta-information recorded for each of a plurality of reference information databases and an attribute of a predetermined project to be proceeded using output data output from the generative model.

### Supplementary Note A5

The information processing apparatus according to any one of supplementary notes A2 to A4, further including a related data analysis means for estimating an attribute of related data used in a predetermined project to be proceeded using output data output from the generative model,
in which the narrow-down means selects a reference information database to be searched based on the meta-information recorded for each of a plurality of reference information databases and an estimation result of the related data analysis means.

### Supplementary Note A6

An information processing apparatus including
an attribute estimation means for estimating an attribute common to reference information recorded in a reference information database for the reference information database in which reference information to be referred to by a generative model trained by machine-learning to generate output data according to an input query is recorded, and
a meta-information recording means for recording the attribute estimated by the attribute estimation means as meta-information of the reference information database.

### Supplementary Note A7

The information processing apparatus according to supplementary note A6, in which the attribute estimation means inputs reference information recorded in the reference information database to a language model trained by machine-learning in such a way as to perform natural language processing to cause estimation of an attribute common to the reference information.

### Supplementary Note A8

The information processing apparatus according to supplementary note A6 or A7, in which in a case where information extracted from one piece of extraction source data is recorded as reference information in one of the reference information databases, the attribute estimation means estimates an attribute of the extraction source data as an attribute common to the reference information extracted from the extraction source data.

### Supplementary Note A9

The information processing apparatus according to any one of supplementary notes A6 to A8, in which in a case where information extracted from extraction source data generated in a predetermined project is recorded as reference information in the reference information database, the attribute estimation means estimates an attribute of the project as an attribute common to the reference information extracted from the extraction source data.

### Supplementary Information B

The present disclosure includes the techniques described in the following supplementary notes. However, the present disclosure is not limited to the techniques described in the following supplementary notes, and various modifications can be made within the scope described in the claims.

### Supplementary Note B1

An information processing method including
narrow-down processing in which at least one processor selects a reference information database to be searched among a plurality of reference information databases based on an attribute recorded as meta-information of a reference information database in which reference information is recorded, the attribute being common to the reference information recorded in the reference information database, and search processing in which the at least one processor searches for reference information to be referred to by a generative model trained by machine-learning to generate output data according to an input query with the reference information database selected by the narrow-down processing as a target.

### Supplementary Note B2

The information processing method according to supplementary note B1, further including
accepting processing in which the at least one processor accepts an input of a query instructing generation of output data, and
generation control processing in which the at least one processor generates a new query by incorporating the reference information detected by the search processing into the query accepted by the accepting processing, and inputs the generated new query to the generative model to cause output data to be generated.

### Supplementary Note B3

The information processing method according to supplementary note B2, further including query analysis processing in which the at least one processor estimates an attribute of the query accepted by the accepting processing by using a language model trained by machine-learning in such a way as to perform natural language processing,
in which in the narrow-down processing, the at least one processor selects a reference information database to be searched based on the meta-information recorded for each of a plurality of reference information databases and an estimation result of the query analysis processing.

### Supplementary Note B4

The information processing method according to supplementary note B2 or B3, in which in the narrow-down processing, the at least one processor selects a reference information database to be searched based on the meta-information recorded for each of a plurality of reference information databases and an attribute of a predetermined project to be proceeded using output data output from the generative model.

### Supplementary Note B5

The information processing method according to any one of supplementary notes B2 to B4, further including related data analysis processing in which the at least one processor estimates an attribute of related data used in a predetermined project to be proceeded using output data output from the generative model,
in which in the narrow-down processing, the at least one processor selects a reference information database to be searched based on the meta-information recorded for each of a plurality of reference information databases and an estimation result of the related data analysis processing.

### Supplementary Note B6

An information processing method including
attribute estimation processing in which the at least one processor estimates an attribute common to reference information recorded in a reference information database for the reference information database in which reference information to be referred to by a generative model trained by machine-learning to generate output data according to an input query is recorded, and meta-information recording processing in which the at least one processor records the attribute estimated in the attribute estimation processing as meta-information of the reference information database.

### Supplementary Note B7

The information processing method according to supplementary note B6, in which in the attribute estimation processing, the at least one processor inputs reference information recorded in the reference information database to a language model trained by machine-learning in such a way as to perform natural language processing to cause estimation of an attribute common to the reference information.

### Supplementary Note B8

The information processing method according to supplementary note B6 or B7, in which in the attribute estimation processing, in a case where information extracted from one piece of extraction source data is recorded as reference information in one of the reference information databases, the at least one processor estimates an attribute of the extraction source data as an attribute common to the reference information extracted from the extraction source data.

### Supplementary Note B9

The information processing method according to any one of supplementary notes B6 to B8, in which in the attribute estimation processing, in a case where information extracted from extraction source data generated in a predetermined project is recorded as reference information in the reference information database, the at least one processor estimates an attribute of the project as an attribute common to the reference information extracted from the extraction source data.

### Supplementary Information C

The present disclosure includes the techniques described in the following supplementary notes. However, the present disclosure is not limited to the techniques described in the following supplementary notes, and various modifications can be made within the scope described in the claims.

### Supplementary Note C1

An information processing program for causing a computer to function as an information processing apparatus, the program causing the computer to function as
a narrow-down means for selecting a reference information database to be searched among a plurality of reference information databases based on an attribute recorded as meta-information of a reference information database in which reference information is recorded, the attribute being common to the reference information recorded in the reference information database, and
a search means for searching for reference information to be referred to by a generative model trained by machine-learning to generate output data according to an input query with the reference information database selected by the narrow-down means as a target.

### Supplementary Note C2

The information processing program according to supplementary note C1, further causing the computer to function as
an accepting means for accepting an input of a query instructing generation of output data, and
a generation control means for generating a new query by incorporating the reference information detected by the search means into the query accepted by the accepting means, and inputting the generated new query to the generative model to cause output data to be generated.

### Supplementary Note C3

The information processing program according to supplementary note C2, further causing the computer to function as a query analysis means for estimating an attribute of the query accepted by the accepting means by using a language model trained by machine-learning in such a way as to perform natural language processing,
in which the narrow-down means selects a reference information database to be searched based on the meta-information recorded for each of a plurality of reference information databases and an estimation result of the query analysis means.

### Supplementary Note C4

The information processing program according to supplementary note C2 or C3, in which the narrow-down means selects a reference information database to be searched based on the meta-information recorded for each of a plurality of reference information databases and an attribute of a predetermined project to be proceeded using output data output from the generative model.

### Supplementary Note C5

The information processing program according to any one of supplementary notes C2 to C4, further causing the computer to function as a related data analysis means for estimating an attribute of related data used in a predetermined project to be proceeded using output data output from the generative model,
in which the narrow-down means selects a reference information database to be searched based on the meta-information recorded for each of a plurality of reference information databases and an estimation result of the related data analysis means.

### Supplementary Note C6

An information processing program causing the computer to function as
an attribute estimation means for estimating an attribute common to reference information recorded in a reference information database for the reference information database in which reference information to be referred to by a generative model trained by machine-learning to generate output data according to an input query is recorded, and
a meta-information recording means for recording the attribute estimated by the attribute estimation means as meta-information of the reference information database.

### Supplementary Note C7

The information processing program according to supplementary note C6, in which the attribute estimation means inputs reference information recorded in the reference information database to a language model trained by machine-learning in such a way as to perform natural language processing to cause estimation of an attribute common to the reference information.

### Supplementary Note C8

The information processing program according to supplementary note C6 or C7, in which in a case where information extracted from one piece of extraction source data is recorded as reference information in one of the reference information databases, the attribute estimation means estimates an attribute of the extraction source data as an attribute common to the reference information extracted from the extraction source data.

### Supplementary Note C9

The information processing program according to any one of supplementary notes C6 to C8, in which in a case where information extracted from extraction source data generated in a predetermined project is recorded as reference information in the reference information database, the attribute estimation means estimates an attribute of the project as an attribute common to the reference information extracted from the extraction source data.

### Supplementary Information D

The present disclosure includes the techniques described in the following supplementary notes. However, the present disclosure is not limited to the techniques described in the following supplementary notes, and various modifications can be made within the scope described in the claims.

### Supplementary Note D1

An information processing apparatus including at least one processor,
in which the at least one processor executes
narrow-down processing of selecting a reference information database to be searched among a plurality of reference information databases based on an attribute recorded as meta-information of a reference information database in which reference information is recorded, the attribute being common to the reference information recorded in the reference information database, and
search processing of searching for reference information to be referred to by a generative model trained by machine-learning to generate output data according to an input query with the reference information database selected in the narrow-down processing as a target.

The information processing apparatus may further include a memory. The memory may store a program for causing the at least one processor to execute each processing.

### Supplementary Note D2

The information processing apparatus according to supplementary note D1, in which the at least one processor further executes
accepting processing of accepting an input of a query instructing generation of output data, and
generation control processing of generating a new query by incorporating the reference information detected by the search processing into the query accepted by the accepting processing, and inputs the generated new query to the generative model to cause output data to be generated.

### Supplementary Note D3

The information processing apparatus according to supplementary note D2, in which
the at least one processor executes query analysis processing of estimating an attribute of the query accepted by the accepting processing by using a language model trained by machine-learning in such a way as to perform natural language processing, and
in the narrow-down processing, the at least one processor selects a reference information database to be searched based on the meta-information recorded for each of a plurality of reference information databases and an estimation result of the query analysis processing.

### Supplementary Note D4

The information processing apparatus according to supplementary note D2 or D3, in which in the narrow-down processing, the at least one processor selects a reference information database to be searched based on the meta-information recorded for each of a plurality of reference information databases and an attribute of a predetermined project to be proceeded using output data output from the generative model.

### Supplementary Note D5

The information processing apparatus according to any one of supplementary notes D2 to D4, in which
the at least one processor executes related data analysis processing of estimating an attribute of related data used in a predetermined project to be proceeded using output data output from the generative model, and
in the narrow-down processing, the at least one processor selects a reference information database to be searched based on the meta-information recorded for each of a plurality of reference information databases and an estimation result of the related data analysis processing.

### Supplementary Note D6

An information processing apparatus in which the at least one processor executes
attribute estimation processing of estimating an attribute common to reference information recorded in a reference information database for the reference information database in which reference information to be referred to by a generative model trained by machine-learning to generate output data according to an input query is recorded, and
meta-information recording processing of recording the attribute estimated in the attribute estimation processing as meta-information of the reference information database.

### Supplementary Note D7

The information processing apparatus according to supplementary note D6, in which in the attribute estimation processing, the at least one processor inputs reference information recorded in the reference information database to a language model trained by machine-learning in such a way as to perform natural language processing to cause estimation of an attribute common to the reference information.

### Supplementary Note D8

The information processing apparatus according to supplementary note D6 or D7, in which in the attribute estimation processing, in a case where information extracted from one piece of extraction source data is recorded as reference information in one of the reference information databases, the at least one processor estimates an attribute of the extraction source data as an attribute common to the reference information extracted from the extraction source data.

### Supplementary Note D9

The information processing apparatus according to any one of supplementary notes D6 to D8, in which in the attribute estimation processing, in a case where information extracted from extraction source data generated in a predetermined project is recorded as reference information in the reference information database, the at least one processor estimates an attribute of the project as an attribute common to the reference information extracted from the extraction source data.

### Supplementary Information E

The present disclosure includes the techniques described in the following supplementary notes. However, the present disclosure is not limited to the techniques described in the following supplementary notes, and various modifications can be made within the scope described in the claims.

### Supplementary Note E1

A non-transitory recording medium recorded with an information processing program for causing a computer to function as an information processing apparatus, the program causing the computer to execute
narrow-down processing of selecting a reference information database to be searched among a plurality of reference information databases based on an attribute recorded as meta-information of a reference information database in which reference information is recorded, the attribute being common to the reference information recorded in the reference information database, and
search processing of searching for reference information to be referred to by a generative model trained by machine-learning to generate output data according to an input query with the reference information database selected in the narrow-down processing as a target.

### Supplementary Note E2

A non-transitory recording medium recorded with an information processing program for causing a computer to function as an information processing apparatus, the program causing the computer to execute
attribute estimation processing of estimating an attribute common to reference information recorded in a reference information database for the reference information database in which reference information to be referred to by a generative model trained by machine-learning to generate output data according to an input query is recorded, and
meta-information recording processing of recording the attribute estimated by the attribute estimation means as meta-information of the reference information database.

1. An information processing apparatus comprising:
at least one memory storing instructions, and
at least one processor configured to execute the instructions to;
select a reference information database to be searched among a plurality of reference information databases based on an attribute recorded as meta-information of a reference information database in which reference information is recorded, the attribute being common to the reference information recorded in the reference information database; and
search for reference information to be referred to by a generative model trained by machine-learning to generate output data according to an input query with the reference information database selected as a target.

2. The information processing apparatus according to claim 1, wherein the at least one processor is further configured to execute the instructions to;
accept an input of a query instructing generation of output data; and
generate a new query by incorporating the detected reference information into the accepted query, and inputting the generated new query to the generative model to cause output data to be generated.

3. The information processing apparatus according to claim 2, wherein the at least one processor is further configured to execute the instructions to;
estimate an attribute of the accepted query by using a language model trained by machine-learning in such a way as to perform natural language processing; and
select a reference information database to be searched based on the meta-information recorded for each of a plurality of reference information databases and the estimation result.

4. The information processing apparatus according to claim 2, wherein the at least one processor is further configured to execute the instructions to select a reference information database to be searched based on the meta-information recorded for each of a plurality of reference information databases and an attribute of a predetermined project to be proceeded using output data output from the generative model.

5. The information processing apparatus according to claim 2, wherein the at least one processor is further configured to execute the instructions to;
estimate an attribute of related data used in a predetermined project to be proceeded using output data output from the generative model; and
select a reference information database to be searched based on the meta-information recorded for each of a plurality of reference information databases and the estimation result.

6. An information processing apparatus comprising:
at least one memory storing instructions, and
at least one processor configured to execute the instructions to;
estimate an attribute common to reference information recorded in a reference information database for the reference information database in which reference information to be referred to by a generative model trained by machine-learning to generate output data according to an input query is recorded; and
record the estimated attribute as meta-information of the reference information database.

7. The information processing apparatus according to claim 6, wherein the at least one processor is further configured to execute the instructions to input reference information recorded in the reference information database to a language model trained by machine-learning in such a way as to perform natural language processing to cause estimation of an attribute common to the reference information.

8. The information processing apparatus according to claim 6, wherein in a case where information extracted from one piece of extraction source data is recorded as reference information in one of the reference information databases, the at least one processor is further configured to execute the instructions to estimate an attribute of the extraction source data as an attribute common to the reference information extracted from the extraction source data.

9. The information processing apparatus according to claim 6, wherein in a case where information extracted from extraction source data generated in a predetermined project is recorded as reference information in the reference information database, the at least one processor is further configured to execute the instructions to estimate an attribute of the project as an attribute common to the reference information extracted from the extraction source data.

10. An information processing method in which at least one processor executes
narrow-down processing of selecting a reference information database to be searched among a plurality of reference information databases based on an attribute recorded as meta-information of a reference information database in which reference information is recorded, the attribute being common to the reference information recorded in the reference information database, and
search processing of searching for reference information to be referred to by a generative model trained by machine-learning to generate output data according to an input query with the reference information database selected by the narrow-down processing as a target.
